(19) United States
(12) Patent Application Publication
(10) Pub. No.: US 2025/0349159 A1
(43) Pub. Date: Nov. 13, 2025

(54) METHOD AND SYSTEM FOR MANAGING VEHICLE DATA

(71) Applicant: TAIGA MOTORS INC., LaSalle (CA)

(72) Inventors: Jean-Philippe LANDRY, Terrebonne (CA); Gabriel BERNATCHEZ, Montreal (CA)

(21) Appl. No.: 19/200,769

(22) Filed: May 7, 2025

Related U.S. Application Data
(60) Provisional application No. 63/644,631, filed on May 9, 2024.

(51) Int. Cl. G07C 5/00; B60L 58/12; G06F 21/62; G07C 5/02

(52) U.S. Cl. CPC G07C 5/008; G06F 21/6218; G07C 5/02; B60L 58/12

(57) ABSTRACT

Systems and methods of communicating trip data to a rider of a powersport vehicle are provided. A method is performed at a server located remotely of the powersport vehicle and includes receiving the trip data from the powersport vehicle and storing the trip data in a first dataset associated with the powersport vehicle. The trip data identifying a route travelled by the rider with the powersport vehicle. After receiving an identification of the rider, the trip data is stored in a second dataset associated with the rider. The rider is granted access to the trip data stored in the second dataset.

### CROSS REFERENCE TO RELATED APPLICATIONS

The application claims priority from U.S. Provisional Application No. 63/644,631 filed on May 9, 2024, entitled Method and System for Managing Vehicle Data, the entire contents of which is hereby incorporated by reference.

### TECHNICAL FIELD

The disclosure relates generally to managing vehicle data, and more particularly to communicating trip data to a rider of a vehicle.

### BACKGROUND

Some riders of powersport vehicles enjoy riding in groups and may also belong to riding clubs of enthusiasts who share the same passion. In order to enhance rider experience, it can be desirable for riders to share past riding experiences. Some ride-tracking software applications can be installed on the rider's portable electronic device (PED). However, such software applications rely on the PED's network connectivity and require the rider to interact with the PED to manage the tracking of rides. This can be inconvenient for the rider especially when the rider is in a remote location without network connectivity or in inclement weather conditions. Improvement is desirable.

### SUMMARY

In one aspect, the disclosure describes a method of communicating trip data to a rider of a powersport vehicle. The method comprises:
at a server located remotely of the powersport vehicle:
receiving the trip data from the powersport vehicle, the trip data identifying a route travelled by the rider with the powersport vehicle;
storing the trip data in a first dataset associated with the powersport vehicle;
receiving an identification of the rider;
storing the trip data in a second dataset associated with the rider; and
granting the rider access to the trip data stored in the second dataset.

Receiving the trip data from the powersport vehicle may include receiving geographic coordinates from the powersport vehicle while the powersport vehicle is in transit.

Receiving the trip data from the powersport vehicle may include receiving a travelling speed from the powersport vehicle while the powersport vehicle is in transit.

The powersport vehicle may include an electric powertrain. Receiving the trip data from the powersport vehicle may include receiving a battery state-of-charge from the powersport vehicle while the powersport vehicle is in transit.

Storing the trip data in the second dataset may be performed in response to receiving the identification of the rider.

The identification of the rider may be received from the powersport vehicle.

The identification of the rider may be received from a portable electronic device of the rider.

The identification of the rider may correspond to an identification of a key used for activating the powersport vehicle.

The method may comprise: receiving additional data from the powersport vehicle, the additional data pertaining to the powersport vehicle and being different from the trip data; and storing the additional data in the first dataset.

Storing the trip data in the second dataset may include copying the trip data from the first dataset to the second dataset.

The method may comprise omitting the additional data from the second dataset.

In some embodiments, part of the route may be travelled by the rider with the powersport vehicle before receiving the identification of the rider at the server or at the powersport vehicle.

The method may comprise:
determining a time duration from when the powersport vehicle has begun travelling the route to when the identification of the rider is received at the server or at the powersport vehicle; and
determining that the time duration is within a prescribed grace period before storing the trip data in the second dataset.

The trip data stored in the second dataset may include the part of the trip data received before receiving the identification of the rider at the server or at the powersport vehicle.

The identification of the rider may be received at the server or at the powersport vehicle before the powersport vehicle has completed travelling the route.

The method may comprise denying the rider access to the first dataset.

The rider may be a first rider. The route may be a first route. The trip data may be first trip data. The method may include: receiving second trip data from the powersport vehicle, the second trip data defining a second route travelled by a second rider using the powersport vehicle; storing the second trip data on the server in the first dataset associated with the powersport vehicle; receiving an identification of the second rider; and storing the second trip data in a third dataset associated with the second rider.

The method may comprise granting the second rider access to the second trip data stored in the third dataset.

The powersport vehicle may be a first powersport vehicle. The route may be a first route. The trip data may be first trip data. The method may include: receiving second trip data from a second powersport vehicle, the second trip data defining a second route travelled by the rider using the second powersport vehicle; storing the second trip data in a third dataset associated with the second powersport vehicle; and storing the second trip data in the second dataset associated with the rider.

The method may comprise granting the rider access to the second trip data stored in the second dataset.

The first dataset may include data values that are not in the second dataset.

Granting the rider access to the trip data stored in the second dataset may include transmitting the trip data to a device associated with the rider.

The method may comprise: receiving personal data associated with the rider while travelling the route; and storing the personal data with the trip data in the second dataset associated with the rider.

The personal data may be omitted from the first dataset.

The personal data may be received from the powersport vehicle.

Embodiments may include combinations of the above features.

In another aspect, the disclosure describes a computer program product for communicating trip data to a rider of a powersport vehicle, the computer program product comprising a non-transitory computer readable storage medium having program code embodied therewith, the program code readable and executable by a computer, processor or logic circuit to perform a method disclosed herein.

In another aspect, the disclosure describes a system for communicating trip data to a rider of a powersport vehicle. The system comprises:
a server in wireless data communication with the powersport vehicle, the server including:
a receiver operable to receive the trip data from the powersport vehicle and to receive an identification of the rider, the trip data defining a route travelled by the rider with the powersport vehicle;
memory operable to store the trip data in a first dataset associated with the powersport vehicle and to store the trip data in a second dataset associated with the rider; and
a processor operable to grant the rider access to the trip data stored in the second dataset.

The trip data may include geographic coordinates. The system may include the powersport vehicle including: a global positioning system receiver operable to generate the geographic coordinates; and a wireless data transmitter operable to wirelessly transmit the geographic coordinates to the server.

The trip data from the powersport vehicle may include a travelling speed of the powersport vehicle while the powersport vehicle is in transit. The wireless data transmitter may be operable to wirelessly transmit the travelling speed to the server.

The powersport vehicle may include an electric powertrain. The trip data from the powersport vehicle may include a battery state-of-charge of the electric powertrain. The wireless data transmitter may be operable to wirelessly transmit the battery state-of-charge to the server.

The processor may be operable to store the trip data in the second dataset in response to receiving the identification of the operator.

The system may comprise a key for activating the powersport vehicle, the identification of the rider corresponding to an identification of the key.

The system may comprise a portable electronic device of the rider in data communication with the powersport vehicle to provide the identification of the rider to the powersport vehicle.

The receiver may be operable to receive additional data from the powersport vehicle, the additional data pertaining to the powersport vehicle and being different from the trip data. The memory may be operable to store the additional data in the first dataset.

The processor may be operable to copy the trip data from the first dataset to the second dataset.

The processor may be operable to omit the additional data from the second dataset.

The server may be configured to, when part of the route is travelled by the rider with the powersport vehicle before receiving the identification of the rider at the server or at the powersport vehicle: determine a time duration from when the powersport vehicle has begun travelling the route to when the identification of the rider is received at the server or at the powersport vehicle; and determine that the time duration is within a prescribed grace period before storing the trip data in the second dataset, the trip data stored in the second dataset including the part of the trip data received before receiving the identification of the rider received at the server or at the powersport vehicle.

The server may be configured to deny the rider access to the first dataset.

The rider may be a first rider. The route may be a first route. The trip data may be first trip data. The receiver may be operable to receive second trip data from the powersport vehicle and to receive an identification of a second rider, the second trip data defining a second route travelled by the second rider using the powersport vehicle. The memory may be operable to store the second trip data in the first dataset associated with the powersport vehicle and to store the second trip data in a third dataset associated with the second rider.

The processor may be operable to grant the second rider access to the second trip data stored in the third dataset.

The powersport vehicle may be a first powersport vehicle. The system may include a second powersport vehicle. The route may be a first route. The trip data may be first trip data. The receiver may be operable to receive second trip data from the second powersport vehicle, the second trip data defining a second route travelled by the rider using the second powersport vehicle. The memory may be operable to store the second trip data in a third dataset associated with the second powersport vehicle and to store the second trip data in the second dataset associated with the rider.

The processor may be operable to grant the rider access to the second trip data stored in the second dataset.

The first dataset may include data values that are not in the second dataset.

The server may include a transmitter operable to transmit the trip data to a device associated with the rider.

The receiver may be operable to receive personal data associated with the rider while travelling the route and store the personal data with the trip data in the second dataset associated with the rider.

The personal data may be excluded from the first dataset.

The personal data may be received from the powersport vehicle.

Embodiments may include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIGS. 1A and 1B are a perspective view and a longitudinal cross-sectional view respectively of an exemplary watercraft which may be used in a method for communicating trip data to a rider of the watercraft;

FIG. 2A is a side elevation view of an exemplary snowmobile which may be used in a method for communicating trip data to a rider of the snowmobile;

FIG. 2B is a partial schematic side elevation view of the snowmobile of FIG. 2A with body panels and other components removed to show internal components of the snowmobile of FIG. 2A;

FIG. 2C is a perspective view of a mid-bay of the snowmobile of FIG. 2A;

FIG. 3 shows an exemplary rider key and start button of a powersport vehicle such as the watercraft of FIG. 1A or the snowmobile of FIG. 2A;

FIG. 4 is a schematic representation of an exemplary communication network which may be used in a method for communicating trip data to a rider of a powersport vehicle;

FIG. 5 is a schematic representation of an exemplary server of the communication network of FIG. 4 together with a schematic representation of a powersport vehicle;

FIG. 6 is a flow diagram of an exemplary method of communicating trip data to a rider of a powersport vehicle;

FIGS. 7 and 8 is are schematic illustrations of exemplary contents of vehicle datasets and rider datasets;

FIG. 9 is an exemplary login window for accessing a software application permitting the rider to manage trip data;

FIG. 10 is an exemplary route recording window of the software application permitting the rider to record trip data; and

FIG. 11 is an exemplary route reviewing window of the software application permitting the rider to review and share trip information.

### DETAILED DESCRIPTION

The present disclosure describes systems and methods for communicating trip data (or information) to riders of vehicles, including powersport vehicles. In some embodiments, the systems and methods described herein may make use of the network connectivity of the vehicle to facilitate ride tracking and communicating trip data to riders. For example, the vehicle may be in wireless communication with a server located remotely of the vehicle so that utilization data associated with the vehicle may be transmitted from the vehicle to the server and stored in a vehicle dataset on the server. The utilization data may be used by authorized personnel for engineering (e.g., research and development) and/or maintenance purposes. Such authorized personnel may include one or more employees of a manufacturer of the vehicle, a retailer of the vehicle, a rental agency for the vehicle and/or a maintenance service provider for the vehicle for example. The utilization data in the vehicle dataset may be protected to safeguard privacy using suitable access control measures to ensure that potentially sensitive data stored in the vehicle dataset is only accessible by the authorized personnel.

The utilization data may include trip data (or ride data) pertaining to a discrete utilization (e.g., a trip or ride) of the vehicle by a rider. Non-limiting examples of such a utilization include round-trip travel, one-way travel, laps of a track, and cumulative travel over a period of time (e.g., one day). In some embodiments, the vehicle may be turned off and on again during a single usage. The rider of the vehicle may be an operator or driver of the vehicle, or may be a passenger of the vehicle, for example.

In some embodiments, trip data may include a definition of a route that has been travelled by one or more riders with the powersport vehicle and one or more operating parameters (e.g., travelling speed and/or energy consumption) of the powersport vehicle exhibited along the route. In some embodiments, the systems and methods described herein may improve the operation of the server by improving data protection of potentially sensitive data. For example, the systems and methods described herein may copy the trip data (i.e., only a subset (or proper subset) of the utilization data) associated with one or more riders from the vehicle dataset into respective one or more rider datasets. The respective riders may be granted access to their respective rider datasets for the purpose of accessing the trip data. Other information in the utilization data may be considered sensitive or confidential engineering data, and might not be copied to the rider datasets to maintain data protection.

Accordingly, the systems and methods described herein may leverage the utilization data that is collected for engineering/maintenance for the purpose of communicating trip data to the rider. Leveraging the collection of the utilization data in this way may provide a ride tracking functionality that is convenient and user-friendly for the rider. For example, in some embodiments, the rider may not need to remember to manually start tracking a ride by interacting with a ride-tracking software application installed on a rider's portable electronic device (PED), or by other active initiation or involvement by the rider.

The use of the rider datasets that are separate from the vehicle dataset(s) may facilitate data protection by allowing the vehicle dataset to remain only accessible by the authorized personnel. Further, the rider datasets may provide a consolidated source of data for a rider including multiple trips using multiple different vehicles. For example, a rider dataset for a particular rider may be maintained when the rider uses and/or purchases a new vehicle. Rider datasets may also include personal data for the rider that might not be stored in a vehicle dataset for privacy reasons. For example, a rider may wear a heartrate monitor during a trip, the data from which may be included in trip data stored in the rider dataset but not in the vehicle dataset.

Aspects of various embodiments are described through reference to the drawings.

The terms “connected” and “coupled” may include both direct connection and coupling in which two elements contact each other, and indirect connection and coupling in which at least one additional element is located between the two elements. The term “substantially” as used herein may be applied to modify any quantitative representation which could permissibly vary without resulting in a change in the basic function to which it is related.

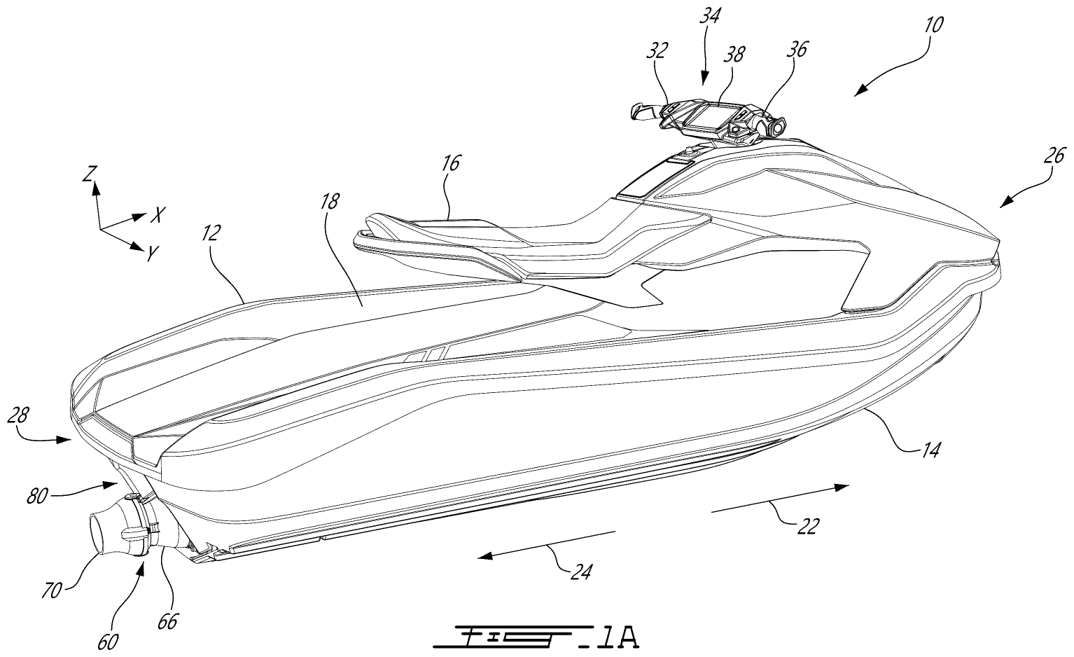

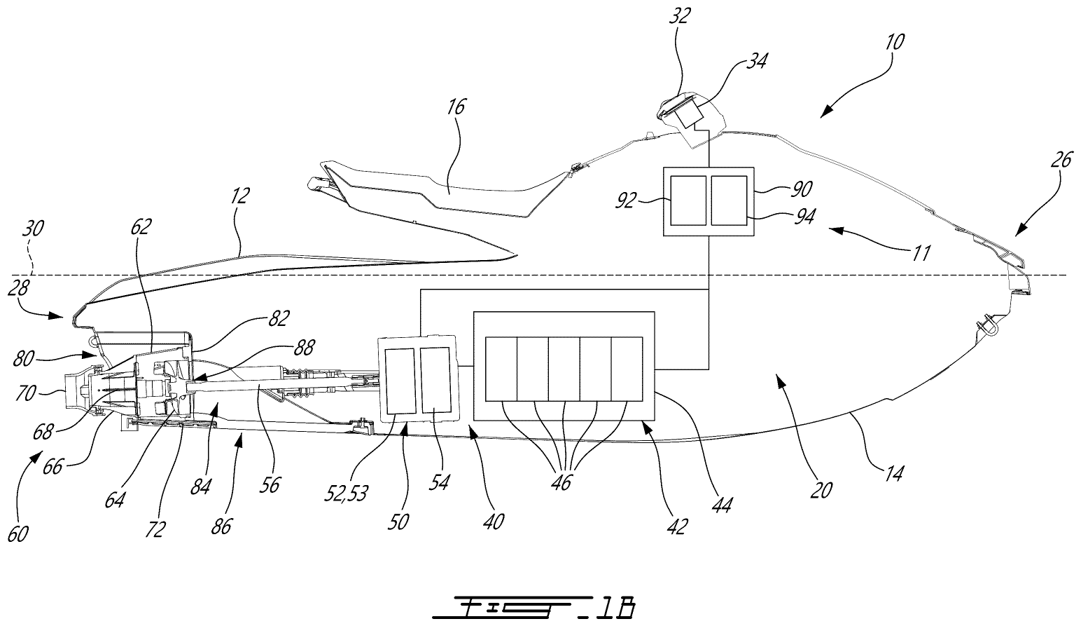

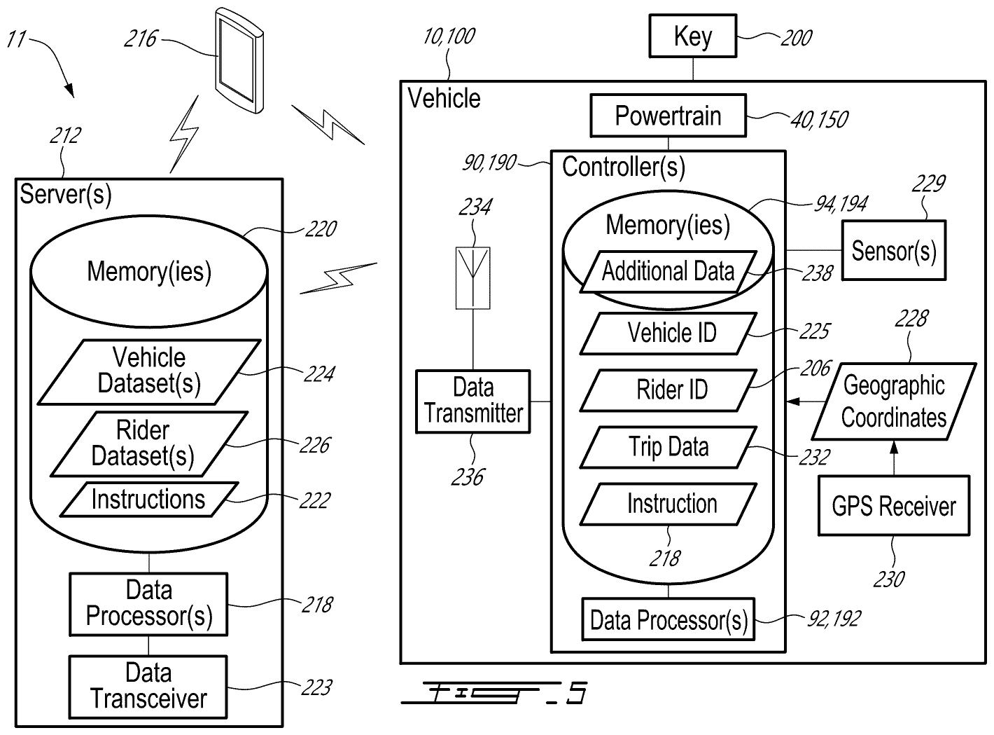

FIGS. 1A and 1B illustrate a perspective view and a longitudinal cross-section view of a watercraft 10, according to an embodiment. The watercraft 10 may be utilized for transporting one or more riders (e.g., an operator and optionally one or more passengers) over a body of water. The watercraft 10 may also be referred to as a “personal watercraft” or “PWC”. Watercraft 10 may form part of system 11 (shown in FIG. 5) for communicating trip information to a rider of watercraft 10.

An upper portion of the watercraft 10 is formed of a deck 12 and a lower portion of the watercraft 10 is formed of a hull 14, which sits in the water. A straddle seat 16 is secured to the deck 12 and sized for accommodating the riders of the watercraft 10. The deck 12 defines foot wells 18 on either side of the straddle seat 16. A steering mechanism 32 (e.g., a set of handlebars) is coupled to the deck 12 forward of the straddle seat 16. The steering mechanism 32 is rotatable by an operator of the watercraft 10 to steer the watercraft 10. The hull 14 and the deck 12 may be coupled together along a seam using adhesives and/or fasteners. When coupled together, the hull 14 and the deck 12 enclose an interior volume 20 of the watercraft 10 which provides buoyancy to the watercraft 10 and houses at least some components thereof.

The watercraft 10 may move along a forward direction of travel 22 and a rear or aft direction of travel 24 (shown in FIG. 1A). The forward direction of travel 22 is the direction along which the watercraft 10 travels in most instances when displacing. The aft direction of travel 24 is the direction along which the watercraft 10 displaces occasionally, such as when reversing. The watercraft 10 includes a bow 26 and a stern 28 defined with respect to the forward direction of travel 22 and the aft direction of travel 24, such that the bow 26 is positioned ahead of the stern 28 relative to the forward direction of travel 22, and that the stern 28 is positioned astern of the bow 26 relative to the aft direction of travel 24. The watercraft 10 defines a longitudinal center axis 30 (shown in FIG. 1B) that extends between the bow 26 and the stern 28. A port side and a starboard side of the watercraft 10 are defined on opposite lateral sides of the center axis 30. The positional descriptors “front”, “aft”, “rear” and terms related thereto are used in the present disclosure to describe the relative position of components of the watercraft 10. For example, if a first component of the watercraft 10 is described herein as being in front of, or forward of, a second component, then the first component is closer to the bow 26 than the second component. Similarly, if a first component of the watercraft 10 is described herein as being aft of, or rearward of, a second component, then the first component is closer to the stern 28 than the second component. The watercraft 10 also includes a three-axes frame of reference that is displaceable with the watercraft 10, where the Z-axis is parallel to the vertical direction and defines heave and yaw (via rotation about the Z-axis) of the watercraft 10, the X-axis is parallel to the center axis 30 and defines surge and roll (via rotation about the X-axis) of the watercraft 10, and the Y-axis is perpendicular to both the X and Z-axes (extending laterally between the starboard and port sides) and defines sway and pitch (via rotation about the Y-axis) of the watercraft 10.

Referring to FIG. 1B, the watercraft 10 is electrically propelled by an electric powertrain 40. The electric powertrain 40 includes an electric battery 42 (also referred to as a “battery pack”), and an electric motor 50. The powertrain 40 is operatively connected to a driveshaft 56 and a jet propulsion system 60. The electric battery 42, motor 50 and driveshaft 56 may be located, in whole or in part, within the interior volume 20 of the watercraft 10. The interior volume 20 may also include other components suitable for use with the watercraft 10 such as storage compartments, a thermal management system, floatation foam and/or a charger, for example. In other embodiments, the watercraft 10 may also or instead be propelled by a powertrain including an internal combustion engine. For example, the motor 50 may also or instead be an internal combustion engine.

The battery 42 includes a battery enclosure 44 housing one or more battery modules 46. In the illustrated example, the battery modules 46 are arranged in a row and/or stacked within the battery enclosure 44. The battery enclosure 44 may support the battery modules 46 and protect the battery modules 46 from external impacts, water and/or other hazards or debris. Each battery module 46 may contain one or more battery cells, such as pouch cells, cylindrical cells and/or prismatic cells, for example. In some implementations, the battery cells are rechargeable lithium-ion battery cells. The battery 42 may also include other components to help facilitate and/or improve the operation of the battery 42, including temperature sensors to monitor the temperature of the battery cells, voltage sensors to measure the voltage of one or more battery cells, current sensors to implement coulomb counting to infer the state of charge (SOC) of the battery 42, and/or thermal channels that circulate a thermal fluid to control the temperature of the battery cells, for example. In some implementations, the battery 42 may output electric power at a voltage between 300 and 800 volts, for example. The watercraft 10 may also include a charger (not shown) to convert alternating current (AC) power from an external power source to direct current (DC) power to charge the battery 42. The charger may include, or be connected to, a charging port positioned forward of the straddle seat 16 to connect to a charging cable from an external power source. In some implementations, the charging port is covered by one or more protective flaps (e.g., made of plastic and/or rubber) to protect the charging port from water and other debris.

It should be noted that the battery 42 illustrated in FIG. 1B is shown by way of example. Other shapes, sizes and configurations of the battery 42 are contemplated. For example, while the battery 42 is shown forward of the motor 50 and driveshaft 56 in FIG. 1B, this need not always be the case. At least a portion of the battery 42 may also, or instead, extend overtop of the motor 50 and/or the driveshaft 56. Further, at least a portion of the battery 42 may be positioned on the port and starboard sides of the motor 50 and/or the driveshaft 56. In some implementations, the battery 42 may include multiple batteries that are interconnected via electrical cables, and housed in one or more battery enclosures 44.

The motor 50 may convert the electric power output from the battery 42 into motive power to drive the jet propulsion system 60 of the watercraft 10. In the illustrated embodiment, the motor 50 is a permanent magnet synchronous motor having a rotor 52 and stator 53. The motor 50 also includes a power electronics module 54 (sometimes referred to as an inverter) to convert the DC power from the battery 42 to AC power having a desired voltage, current and waveform to drive the motor 50. In some implementations, the power electronics module 54 may include one or more capacitors to reduce the voltage variations between the high and low DC voltage leads, and one or more electric switches (e.g., insulated-gate bipolar transistors (IGBTs)) to generate the AC power. In some implementations, the motor 50 has a maximum output power of between 90 KW and 135 KW, for example. In other implementations, the motor 50 has a maximum output power greater than 135 kW.

In some implementations, the motor 50 may include sensors configured to sense one or more parameters of the motor 50. The sensors may be implemented in the rotor 52, the stator 53 and/or the power electronics module 54. The sensors may include a position sensor (e.g., an encoder) to measure a position and/or rotational speed of the rotor 52, and/or a speed sensor (e.g., a revolution counter) to measure the rotational speed of the rotor 52. Alternatively or additionally, the sensors may include a torque sensor to measure an output torque from the motor 50 and/or a current sensor (e.g., a Hall effect sensor) to measure an output current from the power electronics module 54.

Other embodiments of the motor 50 are also contemplated. For example, the power electronics module 54 may be integrated into the housing or casing of motor 50, as shown in FIG. 1B. However, the power electronics module 54 may also, or instead, be provided externally to the housing or casing of the motor 50. In some embodiments, the motor 50 may be a type other than a permanent magnet synchronous motor. For example, the motor 50 may instead be a brushless direct current motor.

The jet propulsion system 60 (also referred to as a “jet pump”) of the watercraft 10 creates a pressurized jet of water which provides thrust to propel the watercraft 10 through the water. A tunnel 80 formed at the stern 28 of the hull 14 at least partially accommodates the jet propulsion system 60. The jet propulsion system 60 includes a housing 62, which is a hollow body that delimits an interior channel or duct of the jet propulsion system 60. The housing 62 is coupled to the hull 14 at a rear wall 82 formed at a front end of the tunnel 80. The hull 14 also at least partially defines a water intake duct 84 having an inlet 86 provided at an underside of the hull 14 and an outlet 88 at the rear wall 82 to provide water to the jet propulsion system 60. In some implementations, a grate may be disposed over the inlet 86 to inhibit the intake of debris into the jet propulsion system 60.

The jet propulsion system 60 includes an impeller 64 positioned within the housing 62 to draw water through the intake duct 84. An inner wall of the housing 62 that surrounds the impeller 64 (referred to as a “wear ring”) may be a component that experiences wear and may be replaced. The impeller 64 is coupled to the motor 50 via the driveshaft 56. The driveshaft 56 extends through the hull 14, the intake duct 84 and the outlet 88 to couple to the impeller 64. The driveshaft 56 transfers motive power from the motor 50 to the impeller 64. The motor 50 is therefore drivingly engaged to the impeller 64. In the illustrated embodiment, the motor 50 is in a direct-drive arrangement with the impeller 64, such that a connection between the motor 50 and the impeller 64 is free of a gearbox. In other embodiments, a transmission may be used to provide a speed ratio between the motor 50 and the impeller 64.

Water ejected from the impeller 64 is directed through a venturi 66 (also referred to as a “nozzle”) formed by the housing 62 that further accelerates the water to provide additional thrust. The venturi 66 includes inwardly extending stator vanes 68 to convert the rotational flow of the water exiting the impeller 64 to thrust. The accelerated water jet is ejected from the venturi 66 via a pivoting steering nozzle 70 to provide a directionally controlled jet of water. The steering mechanism 32 may be mechanically coupled to the steering nozzle 70 to allow an operator to pivot the steering nozzle 70 and steer the watercraft 10. Pivoting the steering nozzle 70 horizontally to direct the water jet towards the port or starboard side of the watercraft 10 may turn the watercraft 10 to either side. The steering nozzle 70 may also pivot vertically to control the trim of the steering nozzle 70, thereby adjusting the running angle of the watercraft 10 in the water. Trimming the steering nozzle 70 upward helps to push the bow 26 of the watercraft 10 upward and may allow for the watercraft 10 to travel faster. Conversely, trimming the steering nozzle 70 downward helps to push the bow 26 of the watercraft 10 into the water which may allow for better navigation of the watercraft 10.

The watercraft 10 further includes a ride plate 72 that is coupled to the hull 14 below the jet propulsion system 60. The ride plate 72 may partially define the intake duct 84 and include a bottom surface that contributes to the ride and handling characteristics of the watercraft 10 in the water. In some implementations, the ride plate 72 may also include a heat exchanger forming part of a thermal management system of the watercraft 10. The heat exchanger may be a closed-loop heat exchanger having channels formed therein to carry a thermal fluid. The thermal fluid in the heat exchanger may be cooled by the water flowing past the ride plate 72, and then be pumped through thermal channels in the battery 42 and the motor 50, for example, to regulate the heat of those components during use. In some embodiments, the thermal management system may also include a heater (not shown) to heat the thermal fluid to provide heating to one or both of the battery 42 and the motor 50.

One or more controllers 90 (referred to hereinafter in the singular) and an instrument panel 34 are part of a control system for controlling operation of the watercraft 10. The instrument panel 34 allows an operator of the watercraft 10 to generate user inputs or instructions for the watercraft 10. The controller 90 is connected to the instrument panel 34 to receive the instructions therefrom and perform operations to implement those instructions. In the illustrated embodiment, the instrument panel 34 is provided on the steering mechanism 32 and the controller 90 is disposed within the interior volume 20, but this need not always be the case.

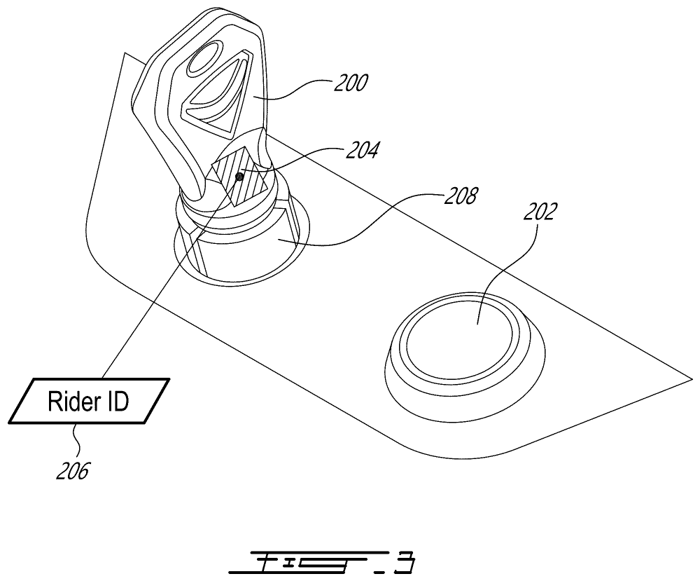

The instrument panel 34 includes an accelerator 36 (also referred to as a “throttle”) to allow an operator to control the thrust generated by the powertrain 40. For example, the accelerator 36 may include a lever to allow the operator to selectively generate an accelerator signal such as propulsion command 37 shown in FIG. 3. The controller 90 is operatively connected to the accelerator 36 and to the motor 50 to receive the propulsion command 37 and produce a corresponding output from the motor 50. In some implementations, the propulsion command 37 is mapped to a rotational speed (e.g., revolutions per minute (RPM)) of the motor 50. When the controller 90 receives propulsion command 37 from the accelerator 36, the controller 90 may map propulsion command 37 to a rotational speed of the motor 50 and control the power electronics module 54 to produce that rotational speed using feedback from sensors in the motor 50. The mapping of propulsion command 37 to an output from the motor 50 may be based on an operating mode (also know as “performance mode”) of the watercraft 10 (e.g., whether the watercraft 10 is in a power-saving operating mode, a normal operating mode or a high-performance operating mode). In some examples, the mapping of propulsion command 37 to an output from the motor 50 may be based on current operating conditions of the powertrain 40 (e.g., a temperature of the battery 42 and/or motor 50, a SOC of the battery 42, etc.). In still other examples, the mapping of propulsion command 37 to an output from the motor 50 may be user-configurable, such that a user may customize an accelerator position to motor output mapping.

The watercraft 10 may be capable of generating reverse thrust to slow down the watercraft 10 when traveling in the forward direction of travel 22 and/or to propel the watercraft 10 in the reverse direction of travel 24. The instrument panel 34 may include a distinct user input device (e.g., a brake lever and/or reverse button) to instruct the controller 90 to generate reverse thrust. In some implementations, reverse thrust is generated by reversing the direction of the motor 50, which draws water in from the steering nozzle 70 and expels the water out from the inlet 86 of the intake duct 84. Alternatively, reverse thrust may be generated using a reverse bucket or deflector gate that deflects the water jet from the venturi 66 forwards, thereby generating reverse thrust.

In addition to the accelerator 36, the instrument panel 34 may include other user input devices (e.g., levers, buttons and/or switches) to control various other functionality of the watercraft 10. These user input devices may be connected to the controller 90, which executes the instructions received from the user input devices. Non-limiting examples of such user input devices include a device to switch the watercraft 10 between different vehicle states (e.g., “off”, “neutral” and “drive” states), a device to switch the watercraft 10 between different operating modes, and a device to adjust the trim of the steering nozzle 70. The instrument panel 34 also includes a display screen 38 (shown in FIG. 1A) connected to the controller 90 that displays information pertaining to the watercraft 10 to an operator. Non-limiting examples of such information include the current state of the watercraft 10, the current operating mode of the watercraft 10, the speed of the watercraft 10, the SOC of the battery 42, the RPM of the motor 50, and the power output from the motor 50. The display screen 38 may include a liquid crystal display (LCD) screen, thin-film-transistor (TFT) LCD screen, light-emitting diode (LED) or other suitable display device. In some embodiments, display screen 38 may be touch-sensitive to facilitate operator inputs.

The controller 90 may also control additional functionality of the watercraft 10. For example, the controller 90 may control a battery management system (BMS) to monitor the SOC of the battery 42 and manage charging and discharging of the battery 42. In another example, the controller 90 may control a thermal management system to manage a temperature of the battery 42 and/or the motor 50 using a thermal fluid cooled by a heat exchanger in the ride plate 72. Temperature sensors in the battery 42 and/or the motor 50 may be connected to the controller 90 to monitor the temperature of these components.

The controller 90 includes one or more data processors 92 (referred hereinafter as “processor 92”) and non-transitory machine-readable memory 94. The memory 94 may store machine-readable instructions which, when executed by the processor 92, cause the processor 92 to perform any computer-implemented method or process described herein. The processor 92 may include, for example, any type of general-purpose microprocessor or microcontroller, a digital signal processing (DSP) processor, an integrated circuit, an application-specific integrated circuit (ASIC), a field programmable gate array (FPGA), a reconfigurable processor, other suitably programmed or programmable logic circuits, or any combination thereof. The memory 94 may include any suitable machine-readable storage medium such as, for example, an electronic, magnetic, optical, electromagnetic, infrared, or semiconductor system, apparatus, or device, or any suitable combination thereof. The memory 94 may be located internally and/or externally to the controller 90.

Although the controller 90 is shown as a single component in FIG. 1B, this is only an example. In some implementations, the controller 90 may include multiple controllers distributed at various locations in the watercraft 10. For example, the controller 90 may include a vehicle control unit (also referred to as a “body controller”) that is responsible for interpreting the inputs from various other controllers in the watercraft 10. Non-limiting examples of these other controllers include a motor controller that is part of the power electronics module 54 and a battery management controller that is part of the battery 42. Optionally, separate battery management controllers may be implemented in the each of the battery modules 46 to form a distributed battery management system.

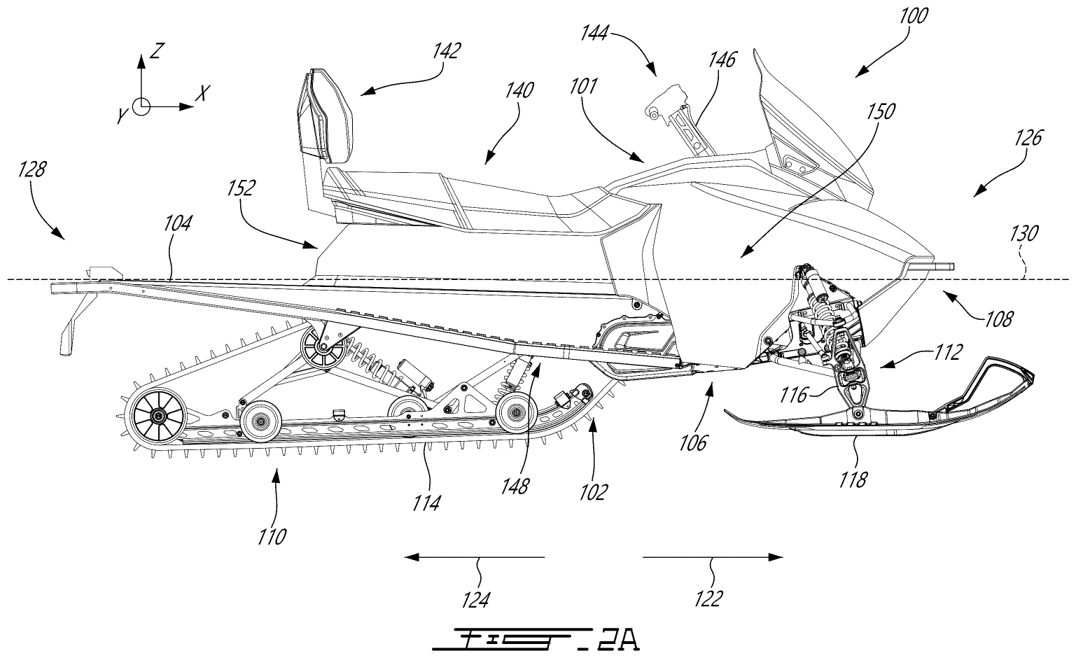

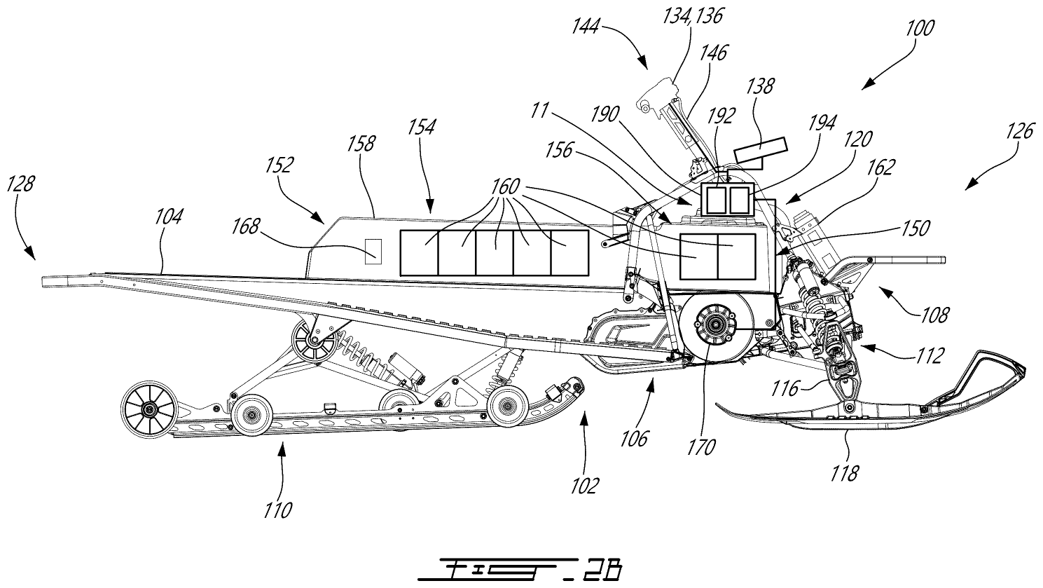

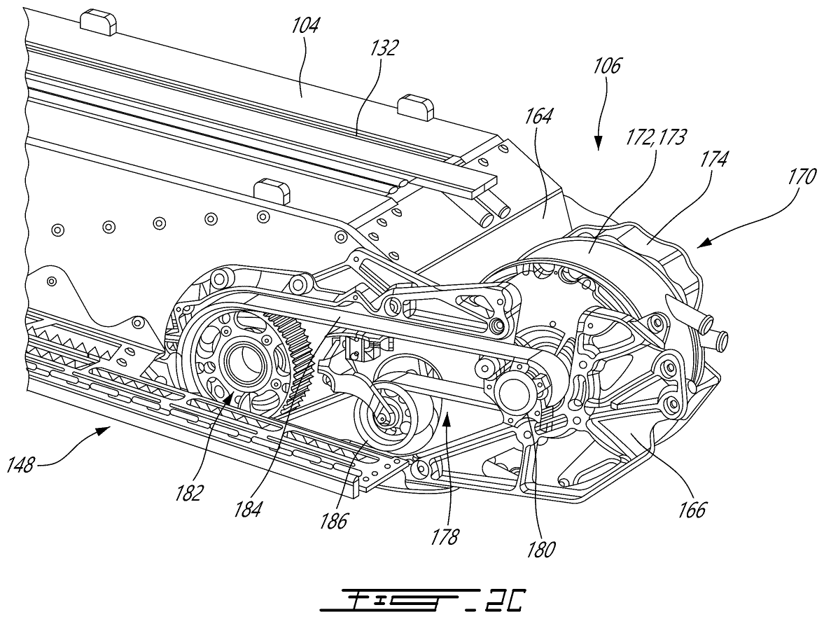

FIG. 2A illustrates a side plan view of a snowmobile 100, according to an embodiment, and FIG. 2B illustrates another side plan view of the snowmobile 100 with several body panels and other components removed so that the interior of the snowmobile 100 may be viewed. Snowmobile 100 may form part of system 11 (shown in FIG. 5) for communicating trip information to a rider of snowmobile 100.

The snowmobile 100 includes a frame 102, which may also be referred to as a “chassis” or “body”, that provides a load bearing framework for the snowmobile 100. In the illustrated embodiment, the frame 102 includes a longitudinal tunnel 104, a mid-bay 106 (or “bulkhead”) coupled forward of the tunnel 104, and a front sub-frame 108 (or “front brace”) coupled forward of the mid-bay 106. In some implementations, the mid-bay 106 may form part of the front sub-frame 108.

The snowmobile 100 also includes a rear suspension assembly 110 and a front suspension assembly 112 to provide shock absorption and improve ride quality. The rear suspension assembly 110 may be coupled to the underside of the tunnel 104 to facilitate the transfer of loads between the rear suspension assembly 110 and the tunnel 104. The rear suspension assembly 110 supports a drive track 114 having the form of an endless belt for engaging the ground (e.g., snow) and propelling the snowmobile 100. The rear suspension assembly may include, inter alia, one or more rails and/or idler wheels for engaging with the drive track 114, and one or more control arms and damping elements (e.g., elastic elements such as coil and/or torsion springs forming a shock absorber) connecting the rails to the tunnel 104. The front suspension assembly 112 includes two suspension legs 116 coupled to the front sub-frame 108 and to respective ground engaging front skis 118 (only one suspension leg 116 and ski 118 are visible in FIGS. 1A and 1B). Each of the suspension legs 116 may include two A-frame arms connected to the front sub-frame 108, a damping element (e.g., an elastic element) connected to the front sub-frame 108, and a spindle connecting the A-frame arms and the damping element to a respective one of the skis 118. The suspension legs 116 transfer loads between the skis 118 and the front sub-frame 108. In the illustrated embodiment, the frame 102 also includes an over structure 120 (shown in FIG. 1B), that may include multiple members (e.g., tubular members) interconnecting the tunnel 104, the mid-bay 106 and/or the front sub-frame 108 to provide additional rigidity to the frame 102. However, as discussed elsewhere herein, the over structure 120 may be omitted in some embodiments.

The snowmobile 100 may move along a forward direction of travel 122 and a rearward direction of travel 124 (shown in FIG. 2A). The forward direction of travel 122 is the direction along which the snowmobile 100 travels in most instances when displacing. The rearward direction of travel 124 is the direction along which the snowmobile 100 displaces only occasionally, such as when it is reversing. The snowmobile 100 includes a front end 126 and a rear end 128 defined with respect to the forward direction of travel 122 and the rearward direction of travel 124. For example, the front end 126 is positioned ahead of the rear end 128 relative to the forward direction of travel 122. The snowmobile 100 defines a longitudinal center axis 130 that extends between the front end 126 and the rear end 128. Two opposing lateral sides of the snowmobile 100 are defined parallel to the center axis 130. The positional descriptors “front”, “rear” and terms related thereto are used in the present disclosure to describe the relative position of components of the snowmobile 100. For example, if a first component of the snowmobile 100 is described herein as being in front of, or forward of, a second component, then the first component is closer to the front end 126 than the second component. Similarly, if a first component of the snowmobile 100 is described herein as being behind, or rearward of, a second component, then the first component is closer to the rear end 128 than the second component. The snowmobile 100 also includes a three-axes frame of reference that is displaceable with the snowmobile 100, where the Z-axis is parallel to the vertical direction, the X-axis is parallel to the center axis 130, and the Y-axis is parallel to the lateral direction.

The snowmobile 100 is configured to carry one or more riders, including a driver (sometimes referred to as an “operator”) and optionally one or more passengers. In the illustrated example, the snowmobile 100 includes a straddle seat 140 to support the riders. Optionally, the straddle seat 140 includes a backrest 142. The operator of the snowmobile 100 may steer the snowmobile 100 using a steering mechanism 144 (e.g., handlebars), which are operatively connected to the skis 118 via a steering shaft 146 to control the direction of the skis 118. The tunnel 104 may also include or be coupled to footrests 148 (also referred to as “running boards”), namely left and right footrests each sized for receiving a foot of one or more riders sitting on the straddle seat 140.

Referring to FIG. 2B, the snowmobile 100 is electrically propelled by an electric powertrain 150. The powertrain 150 includes an electric battery 152 (also referred to as a “battery pack”) and an electric motor 170. The battery 152 is electrically connected to the motor 170 to provide electric power to the motor 170. The motor 170, in turn, is drivingly coupled to the drive track 114 to propel the snowmobile 100 across the ground. In other embodiments, the snowmobile 100 may also or instead be propelled by a powertrain including an internal combustion engine. For example, the motor 170 may also or instead be an internal combustion engine.

The battery 152 may include a battery enclosure 158 that houses one or more battery modules 160. The battery enclosure 158 may support the battery modules 160 and protect the battery modules 160 from external impacts, water and/or other hazards or debris. Each battery module 160 may contain one or more battery cells, such as pouch cells, cylindrical cells and/or prismatic cells, for example. In some implementations, the battery cells are rechargeable lithium-ion battery cells. The battery 152 may also include other components to help facilitate and/or improve the operation of the battery 152, including temperature sensors to monitor the temperature of the battery cells, voltage sensors to measure the voltage of one or more battery cells, current sensors to implement coulomb counting to infer the state of charge (SOC) of the battery 42, and/or thermal channels that circulate a thermal fluid to control the temperature of the battery cells. In some implementations, the battery 152 may output electric power at a voltage of between 300 and 800 volts, for example. The snowmobile 100 may also include a charger 162 to convert AC to DC current from an external power source to charge the battery 152. The charger 162 may include, or be connected to, a charging port positioned forward of the straddle seat 140 to connect to a charging cable from an external power source. In some implementations, the charging port is covered by one or more protective flaps (e.g., made of plastic and/or rubber) to protect the charging port from water, snow and other debris.

In some implementations, the battery 152 may be generally divided into a tunnel battery portion 154 and a mid-bay battery portion 156. The tunnel battery portion 154 may be positioned above and coupled to the tunnel 104. As illustrated, the straddle seat 140 is positioned above the tunnel battery portion 154 and, optionally, the straddle seat 140 may be supported by the battery enclosure 158 and/or internal structures within the battery 152. The mid-bay battery portion 156 extends into the mid-bay 106 and may be coupled to the mid-bay 106 and/or to the front sub-frame 108. The tunnel battery portion 154 and the mid-bay battery portion 156 may share a single battery enclosure 158, or alternatively separate battery enclosures. In the illustrated example, the tunnel battery portion 154 and the mid-bay battery portion 156 each include multiple battery modules 160 that are arranged in a row and/or stacked within the battery enclosure 158.

It should be noted that other shapes, sizes and configurations of the battery 152 are contemplated. For example, the battery 152 may include multiple batteries that are interconnected via electrical cables. In some embodiments, the battery enclosure 158 may be a structural component of the snowmobile 100 and may form part of the frame 102. For example, the battery enclosure 158 may be coupled to the front sub-frame 108 to transfer loads between the front sub-frame 108 and the tunnel 104. The battery enclosure 158 may be formed from a fiber composite material (e.g., a carbon fiber composite) for additional rigidity. Optionally, in the case that the battery enclosure 158 is a structural component of the snowmobile 100, the over structure 120 may be omitted.

FIG. 2C is a perspective view of the mid-bay 106 of the snowmobile 100. As illustrated, the motor 170 is disposed in a lower portion of the mid-bay 106, below the mid-bay battery portion 156 and forward of a wall 164 defining a front end of the tunnel 104. The motor 170 may be mounted to a transmission plate 166 that is supported between the tunnel 104 and the front sub-frame 108 to help support the motor 170 within the mid-bay 106.

In the illustrated embodiment, the motor 170 is a permanent magnet synchronous motor having a rotor 172 and stator 173. The motor 170 also includes power electronics module 174 (sometimes referred to as an inverter) to convert the direct current (DC) power from the battery 152 to alternating current (AC) power having a desired voltage, current and waveform to drive the motor 170. In some implementations, the power electronics module 174 may include one or more capacitors to reduce the voltage variations between the high and low DC voltage leads, and one or more electric switches (e.g., insulated-gate bipolar transistors (IGBTs)) to generate the AC power. In some implementations, the motor 170 has a maximum output power of between 90 kW and 135 kW. In other implementations, the motor 170 has a maximum output power greater than 135 kW.

In some implementations, the motor 170 may include sensors configured to sense one or more parameters of the motor 170. The sensors may be implemented in the rotor 172, the stator 173 and/or the power electronics module 174. The sensors may include a position sensor (e.g., an encoder) to measure a position and/or rotational speed of the rotor 172, and/or a speed sensor (e.g., a revolution counter) to measure the rotational speed of the rotor 172. Alternatively or additionally, the sensors may include a torque sensor to measure an output torque from the motor 170 and/or a current sensor (e.g., a Hall effect sensor) to measure an output current from the power electronics module 174.

Other embodiments of the motor 170 are also contemplated. For example, the power electronics module 174 may be integrated into the housing or casing of motor 170, as shown in FIG. 2C. However, the power electronics module 174 may also, or instead, be provided externally to the housing or casing of motor 170. In some embodiments, the motor 170 may be a type other than a permanent magnet synchronous motor. For example, the motor 170 may instead be a brushless direct current motor.

The motor 170 may convert the electric power output from the battery 152 into motive power that is transferred to the drive track 114 via a drive transmission 178. The drive transmission 178 engages with a motor drive shaft 180 of the motor 170. The motor drive shaft 180 may extend laterally through an opening in the transmission plate 166. The drive transmission 178 includes a track drive shaft 182 that extends laterally across the tunnel 104. The motor drive shaft 180 and the track drive shaft 182 may extend parallel to each other along transverse axes of the snowmobile 100 and may be spaced apart from each other along the longitudinal axis 130. In the illustrated embodiment, the motor drive shaft 180 is operably coupled to the track drive shaft 182 via a drive belt 184.

Sprockets on the motor drive shaft 180 and the track drive shaft 182 may engage with lugs on the drive belt 184. A drive belt idler pulley 186 may also be implemented to maintain tension on the drive belt 184. In other embodiments, another form of linkage such as a drive chain, for example, may operatively connect the motor drive shaft 180 and the track drive shaft 182.

In operation, torque from the motor 170 is transferred from the motor drive shaft 180 to the track drive shaft 182 via the drive belt 184. The track drive shaft 182 includes one or more sprockets (not shown) that engage with lugs on the drive track 114, thereby allowing the track drive shaft 182 to transfer motive power to the drive track 114. It will be understood that the motor 170 may be operated in two directions (i.e., rotate clockwise or counter-clockwise), allowing the snowmobile 100 to travel in the forward direction of travel 122 and in the rearward direction of travel 124. In some implementations, the drive track 114 and the snowmobile 100 may be slowed down via electrical braking (e.g., regenerative braking) implemented by the motor 170 and/or by a mechanical brake (e.g., a disc brake) connected to one of the track drive shaft 182 or the motor drive shaft 180.

The snowmobile 100 may include a heat exchanger 132 that is coupled to, or integrated with, the tunnel 104. The heat exchanger 132 may form part of a thermal management system to control the temperature of the battery 152, the motor 170 and the charger 162, for example. The heat exchanger may include channels to carry a thermal fluid along a portion of the tunnel 104. During operation of the snowmobile 100, the heat exchanger 132 may be exposed to snow and cold air circulating in the tunnel 104 that cools the thermal fluid. The thermal fluid may then be pumped through thermal channels in the battery 152, the motor 170 and/or the charger 162, for example, to cool those components. In some implementations, the thermal management system of the snowmobile 100 may also include a heater 168 (shown in FIG. 2B) to heat the thermal fluid and warm the battery 152. Warming the battery 152 may be useful if the snowmobile 100 has been left for an extended period in a cold environment. In such a case, the temperature of the battery cells in the battery modules 160 may fall to a level where high power is limited from being drawn from the battery 152. Warming the battery 152 may bring the battery cells back into an efficient operating regime. In some implementations, the heater 168 is disposed within the battery enclosure 158.

Referring again to FIG. 2B, one or more controllers 190 (referred to hereinafter in the singular) and an instrument panel 134 are part of a control system for controlling operation of the snowmobile 100. The instrument panel 134 allows an operator of the snowmobile 100 to generate user inputs and/or instructions for the snowmobile 100. The controller 190 is connected to the instrument panel 134 to receive the instructions therefrom and perform operations to implement those instructions. In the illustrated embodiment, the instrument panel 134 is provided on the steering mechanism 144 and the controller 190 is disposed within the interior of the snowmobile 100, but this need not always be the case.

The instrument panel 134 includes an accelerator 136 (also referred to as a “throttle”) to allow an operator to control the power generated by the powertrain 150. For example, the accelerator 136 may include a lever to allow the operator to selectively generate an accelerator signal. The controller 190 is operatively connected to the accelerator 136 and to the motor 170 to receive the accelerator signal and produce a corresponding output from the motor 170. In some implementations, the accelerator signal is mapped to a torque of the motor 170. When the controller 190 receives an accelerator signal from the accelerator 136, the controller 190 maps the accelerator signal to a torque of the motor 170 and controls the power electronics module 174 to produce that torque using feedback from sensors in the motor 50. The mapping of the accelerator signal to an output from the motor 170 may be based on a performance mode of the snowmobile 100 (e.g., whether the snowmobile 100 is in a power-saving mode, a normal mode or a high-performance mode). In some examples, the mapping of the accelerator signal to an output from the motor 170 may be based on current operating conditions of the powertrain 150 (e.g., temperature of the battery 152 and/or motor 170, state of charge of the battery 152, etc.). In still other examples, the mapping of the accelerator signal to an output from the motor 170 may be user configurable, such that a user may customize an accelerator position to motor output mapping.

In addition to the accelerator 36, the instrument panel 134 may include other user input devices (e.g., levers, buttons and/or switches) to control various other functionality of the snowmobile 100. These user input devices may be connected to the controller 190, which executes the instructions received from the user input devices. Non-limiting examples of such user input devices include a brake lever to implement mechanical and/or electrical braking of the snowmobile 100, a reverse option to propel the snowmobile 100 in the rearward direction of travel 124, a device to switch the snowmobile 100 between different vehicle states (e.g., “off”, “neutral” and “drive” states), a device to switch the snowmobile 100 between different performance modes, a device to switch between regenerative braking modes (e.g. “off”, “low” and “high” modes) and a device to activate heating of handgrips of the steering mechanism. The snowmobile 100 also includes a display screen 138 connected to the controller 190. The display screen 138 may be provided forward of the steering mechanism 144, or in any other suitable location depending on the design of the snowmobile 100. The display screen 138 displays information pertaining to the snowmobile 100 to an operator. Non-limiting examples of such information include the current state of the snowmobile 100, the current performance mode of the snowmobile 100, the speed of the snowmobile 100, the state of charge (SOC) of the battery 152, the angular speed of the motor 170, and the power output from the motor 170. The display screen 138 may include a liquid crystal display (LCD) screen, thin-film-transistor (TFT) LCD screen, light-emitting diode (LED) or other suitable display device. In some embodiments, display screen 138 may be touch-sensitive to facilitate operator inputs.

The controller 190 may also control additional functionality of the snowmobile 100. For example, the controller 190 may control a battery management system (BMS) to monitor the SOC of the battery 152 and manage charging and discharging of the battery 152. In another example, the controller 190 may control a thermal management system to manage a temperature of the battery 152, the motor 170 and/or the charger 162 using a thermal fluid cooled by the heat exchanger 132 and/or heated by the heater 168. Temperature sensors in the battery 152 and/or the motor 170 may be connected to the controller 190 to monitor the temperature of these components.

The controller 190 includes one or more data processors 192 (referred hereinafter as “processor 192”) and non-transitory machine-readable memory 194. The memory 194 may store machine-readable instructions which, when executed by the processor 192, cause the processor 192 to perform any computer-implemented method or process described herein. The processor 192 may include, for example, any type of general-purpose microprocessor or microcontroller, a digital signal processing (DSP) processor, an integrated circuit, an application-specific integrated circuit (ASIC), a field programmable gate array (FPGA), a reconfigurable processor, other suitably programmed or programmable logic circuits, or any combination thereof. The memory 194 may include any suitable machine-readable storage medium such as, for example, an electronic, magnetic, optical, electromagnetic, infrared, or semiconductor system, apparatus, or device, or any suitable combination thereof. The memory 194 may be located internally and/or externally to the controller 190.

Although the controller 190 is shown as a single component in FIG. 2B, this is only an example. In some implementations, the controller 190 may include multiple controllers distributed at various locations in the snowmobile 100. For example, the controller 190 may include a vehicle control unit (also referred to as a “body controller”) that is responsible for interpreting the inputs from various other controllers in the snowmobile 100. Non-limiting examples of these other controllers include a motor controller that is part of the power electronics module 174 and a battery management controller that is part of the battery 152. Optionally, separate battery management controllers may be implemented in the each of the battery modules 160 to form a distributed battery management system.

Systems and methods are described below and shown in the present disclosure in relation to vehicle 10, 100 intended to encompass watercraft 10 and snowmobile 100. However, the present disclosure may also be applied to other types of powersport vehicles such as motorcycles, all-terrain vehicles (ATVs), and utility task vehicles (UTVs) (e.g., side-by-side) for example. Moreover, the present disclosure may be applied more generally to other vehicles including road vehicles and aircraft.

FIG. 3 shows an exemplary operator key 200 and start button 202 of vehicle 10, 100. In some embodiments, key 200 may be in communication with vehicle 10, 100 via a suitable near-field communication (NFC) protocol to provide contactless identification of the rider, who may be the operator of vehicle 10, 100. For example, key 200 may be part of a radio-frequency identification (RFID) system of vehicle 10, 100. Key 200 may include RFID tag 204 which may store data such as rider identification 206 (referred hereinafter as “rider ID 206”) identifying key 200 and/or a specific rider associated with key 200. When triggered by an electromagnetic interrogation pulse from a RFID reader device associated with vehicle 10, 100, RFID tag 204 may wirelessly transmit the data stored on RFID tag 204 and the data may be used by controller 90, 190 to authenticate key 200 and either permit or prevent the operation of vehicle 10, 100 based on the data. In some embodiments, key 200 may interact with a software-based or physical/mechanical hardware-based switch disposed within receptacle 208 so that the insertion and withdrawal of key 200 into and out of receptacle 208 may cause key 200 to interface with and actuate such switch, and signal to controller 90, 190 the rider's authorization to use vehicle 10, 100. In some embodiments, vehicle 10, 100 may include a (e.g., rotary) switch that is actuatable with key 200.

Key 200 may permit the operation of vehicle 10, 100 when key 200 is received into receptacle 208 or when key 200 is in sufficient proximity to vehicle 10, 100 for example. The presence of key 200 may be communicated to controller 90, 190 to authorize the activation and/or operation of vehicle 10, 100. Key 200 may be attached to one end of a tether (e.g., lanyard) where the opposite end of the tether may be attached to the rider's clothing, belt, or (e.g., for watercraft use) personal flotation device during operation of vehicle 10, 100.

Start button 202 may be disposed in proximity to receptacle 208. Start button 202 may be operatively connected to controller 90, 190 to generate one or more vehicle activation commands to cause vehicle 10, 100 to transition from an inactive (off) to an active (on) state for example. The active (on) state may comprise an “awake” state, where the vehicle is on but unresponsive to acceleration commands, and a “ready” (on) state where the vehicle is on and responsive to acceleration commands.

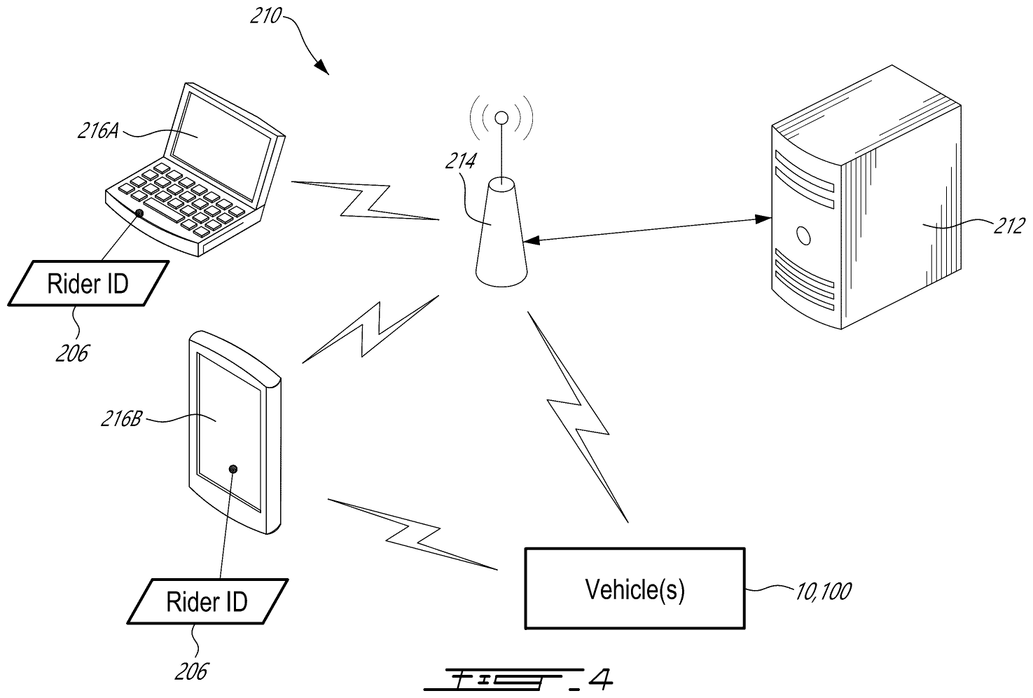

FIG. 4 is a schematic representation of an exemplary communication network 210 including one or more vehicles 10, 100. Communication network 210 may include one or more servers 212 (referred hereinafter in the singular) in wireless data communication with one or more vehicles 10, 100. Accordingly, server 212 may be in wireless data communication with a plurality of vehicles including fleets of vehicles. Communication network 210 may include one or more network antennas 214. Communication network 210 may include a local area network (LAN), wide area network (WAN), cellular (e.g., 4G or Long-Term Evolution (LTE)) network, internet-based network, satellite-based network, Wi-Fi or other suitable type of network.

Communication network 210 may include one or more portable electronic devices 216A, 216B (referred hereinafter in the singular and generally as “PED 216”) such as a wearable, a smartphone, a tablet computer and/or a laptop computer for example. PED 216 may be capable of direct wireless or wired data communication (e.g., paired via Bluetooth® or connected via a physical data port) with vehicle 10, 100, or indirect wireless data communication with vehicle 10, 100 via other elements of communication network 210. PED 216 may also be capable of (e.g., wireless) data communication with server 212. In some embodiments, PED 216 may be operable to access a webpage or run an application (app) associated with vehicle 10, 100 and access some data stored on server 212. In some embodiments, rider ID 206 may be stored in a memory of PED 216 and may be acquired from the rider via PED 216. For example, rider ID 206 may include or be associated with a user name, email address, phone number or other identifier stored on PED 216 and/or input into PED 216 by the rider. Rider ID 206 may be communicated from PED 216 to server 212 and/or to vehicle 10, 100 for the purpose of tracking rides and to permit the rider to access trip data stored on server 212 and associated with rider ID 206. More specifically, rider ID 206 may be determined by vehicle 10, 100 automatically via wireless exchange when PED 216 is in proximity to vehicle 10, 100. Accordingly, vehicle 10, 100 receives the rider ID 206 without active involvement from the user of PED 216. The presence and identity of the rider in proximity to vehicle 10, 100 and/or the authorization of the rider to operate vehicle 10, 100 may be established by proxy by detecting and communicating with PED 216 which may be carried by the rider. Rider ID 206 may be an identifier of the driver of the vehicle 10, 100 or a passenger of the vehicle 10, 100. In a situation where both a driver and a passenger are riding on vehicle 10, 100, their respective rider IDs 206 may be received by vehicle 10, 100 from their respective PEDs 216 and both rider IDs 206 may identified in connection with the trip data.

Alternatively or in addition, the rider's authorization to operate vehicle 10, 100, and/or the identification of the rider may be established by way of an identification code and/or password that may be manually entered by the rider via an instrument panel of vehicle 10, 100 or via PED 216 in communication with vehicle 10, 100 permitting the rider to interact with and provide inputs to vehicle 10, 100.

FIG. 5 is an exemplary schematic representation of server 212 of communication network 210 of FIG. 4 together with a schematic representation of vehicle 10, 100. Server 212 may include a computer configured for (e.g., wireless) data communication with vehicle 10, 100, with PED 216 and/or with other elements of communication network 210 via antenna 214. Server 212 may include one or more computing devices and one or more data storage and retrieval devices remote of vehicle 10, 100. For example, server 212 may include one or more data processors 218 (referred hereinafter in the singular as “processor 218”) operatively connected to memory 220. Processor 218 may include any suitable device(s) configured to cause a series of steps to be performed by server 212 so as to implement a computer-implemented process such that instructions 222, when executed by server 212 or other programmable apparatus, may cause the functions/acts specified in the methods described herein to be executed. Memory 220 may include any suitable machine-readable storage medium. Memory 220 may include non-transitory computer readable storage medium (e.g. devices) suitable for retrievably storing machine-readable instructions 222 executable by processor 218.

Server 212 may be in continuous or periodic data communication with vehicle 10, 100 and optionally also with PED 216 to facilitate ride tracking and also facilitate the communication of trip data with the rider. Server 212 may include data transceiver 223 operatively connected to a data processor 218 to permit (e.g., wireless) data communication between server 212 and vehicle 10, 100. Data transceiver 223 may include a data receiver and a data transmitter. Server 212 may be configured for cloud computing to deliver hosted services over the internet (e.g., Amazon Web Services™). As explained further below, server 212 may (e.g., wirelessly) collect utilization data from vehicle 10, 100 that is stored in vehicle dataset 224 in memory 220 of server 212. Memory 220 may store a plurality of vehicle datasets 224 respectively associated with a plurality of vehicles 10, 100 each having a corresponding vehicle identification 225 (referred hereinafter as “vehicle ID 225”). The utilization data may contain trip data 232 which may be of interest to the rider and additional data 238 which may be of interest to the manufacturer or maintenance provider. Trip data 232 may include definitions of routes travelled by vehicle 10, 100. Using rider ID 206, server 212 may copy trip data 232 associated with rider ID 206 in a separate rider dataset 226. In other words, a second instance of the applicable trip data 232 may be stored in rider dataset 226. The rider (e.g., using PED 216) may then be granted access to the trip data 232 stored in their rider dataset 226 but may not be granted access to vehicle dataset 224. The rider may be denied access to vehicle dataset 224. Rider dataset 226 may be tied to a user account of the rider.

The use of a separate rider dataset 226 accessible to the rider may facilitate protection and controlled access to vehicle dataset 224. For example, vehicle dataset 224 may be protected by a different firewall than rider dataset 226 and the different firewall may implement different security rules for accessing vehicle dataset 224 than for accessing rider dataset 226.

Vehicle 10, 100 may include a satellite navigation device, referred herein as a global positioning system (GPS) receiver 230, operatively connected to controller 90, 190. GPS receiver 230 may be capable of receiving (sensing) information from global navigation satellite systems (GNSS) satellites that may be used to calculate a geographical position of vehicle 10, 100. GPS receiver 230 may generate geographic coordinates 228, sometimes call “GPS breadcrumbs”, that track the path (i.e., route definition(s)) travelled by vehicle 10, 100. Geographic coordinates 228 may be transmitted to server 212. Geographic coordinates 228 may define route definitions that are stored in vehicle dataset 224 and also in rider dataset 226. In other words, the route definitions may each include a plurality of geographic coordinates 228 that define a route travelled by vehicle 10, 100.

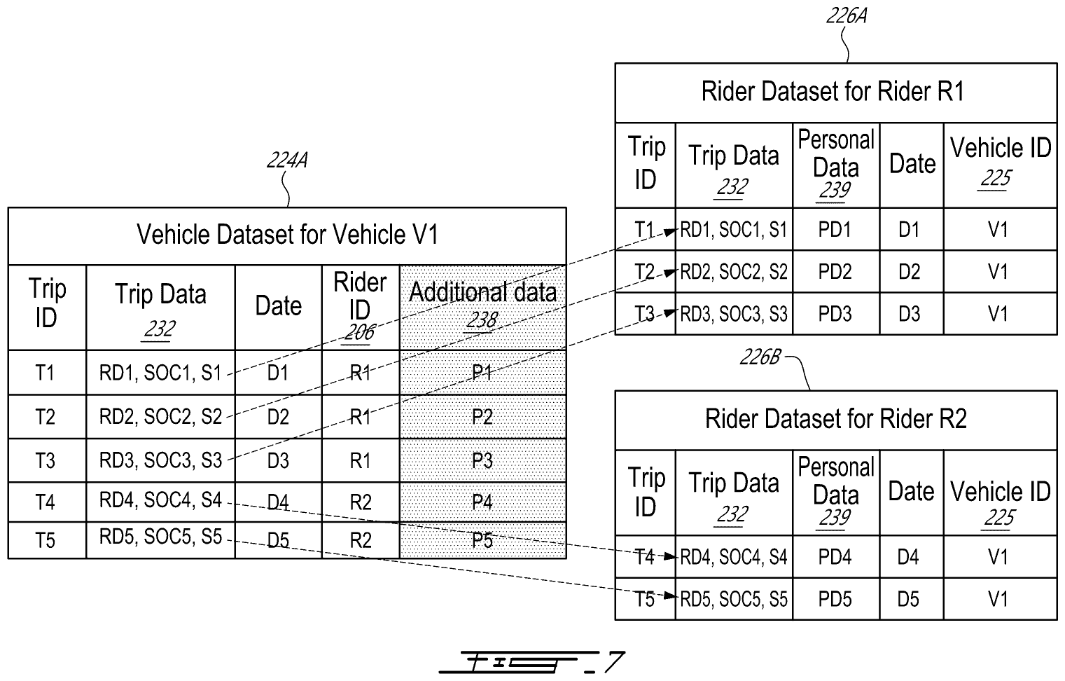

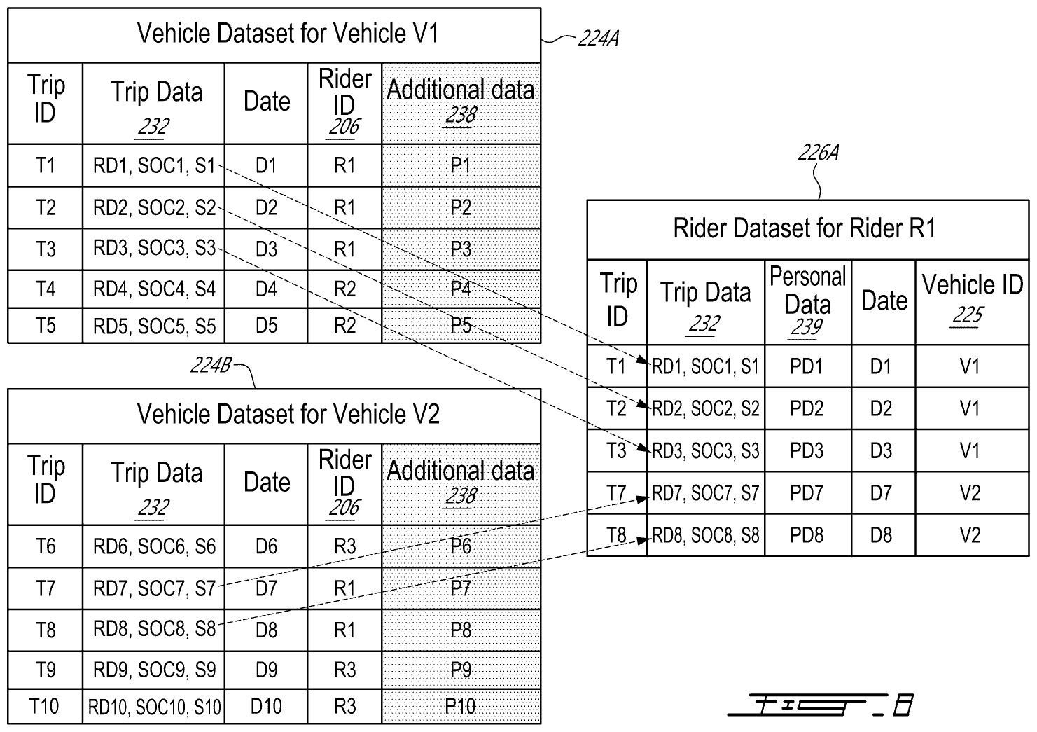

Vehicle 10, 100 may also include one or more sensor(s) 229 to measure operating parameters of vehicle 10, 100 during use. Non-limiting examples of such parameters may include the speed of vehicle 10, 100, acceleration of vehicle 10, 100, temperature(s) of battery 42, 152 and/or motor 50, 170, voltage(s) of battery 42, 152, SOC of battery 42, 152, electric current drawn by motor 50, 170, power produced by motor 50, 170, torque produced by motor 50, 170, etc. At least some (e.g., a first subset) of parameters may form part of trip data 232 stored in vehicle dataset 224 and also in rider dataset 226. However, at least some (e.g., a second disjoint or non-overlapping subset) of parameters may be stored in vehicle dataset 224 but might not be stored in rider dataset 226. These other parameters may include confidential or proprietary data (e.g., engineering and/or maintenance data) restricted to authorized personnel only and may be stored as additional data 238 (shown in FIGS. 7 and 8).

By way of example, a first subset of parameters that form part of trip data 232 viewable by a rider may include speed of vehicle 10, 100, SOC of battery 42, 152, power produced by motor 50, 170, and torque produced by motor 50, 170 whereas a second, disjoint subset of parameters may include temperature(s) of battery 42, 152 and/or motor 50, 170, voltage(s) of battery 42, 152, and electric current drawn by motor 50, 170. The first subset of parameters may include parameters that are not confidential and are interesting to a rider, and the second subset of parameters may be considered confidential engineering data mainly used for product development and maintenance purposes by authorized personnel. The second subset may include vehicle error codes, maintenance and/or servicing warnings and other information relevant to servicing, maintenance or vehicle manufacturers.

In some embodiments, rider dataset 226 may include data or information not included in vehicle dataset 224. Such data may include a rider's personal data 239 (shown in FIGS. 7 and 8) that is optionally associated with a route travelled by the rider. Non-limiting examples of personal data include images, audio and/or videos captured by the rider while travelling the route and biometric data (e.g., heart rate, blood pressure, blood oxygen, respiratory rate, etc.) for the rider collected while travelling the route. In some implementations, personal data 239 may be collected by vehicle 10, 100 and transmitted to server 212. However, this need not always be the case. In some implementations, personal data 239 may be collected, at least in part, by PED 216 and/or another device associated with the rider (e.g., heart rate data might be collected by a wearable, such as a smart watch or dedicated heart rate monitor) and transmitted to server 212. To facilitate protection and controlled access to a rider's personal data, server 212 might only store such data in rider dataset 224, thereby restricting access to personal data 239 by engineering and maintenance personnel.

Vehicle 10, 100 may include one or more onboard antennas 234 (referred hereinafter in the singular) operatively connected to a wireless data transmitter 236 (e.g., transceiver) and to controller 90, 190 to permit wireless over-the-air transmission and optionally receipt of data to and from vehicle 10, 100. Alternatively, or in addition, vehicle 10, 100 may include physical data port (e.g., Universal Serial Bus (USB)) to permit wired data communication (e.g., receipt and transmission) with PED 216. Onboard antenna 234 and/or other physical data port(s) may permit the utilization data to be transmitted from vehicle 10, 100 to server 212. The utilization data may include geographic coordinates 228 defining route definitions of trip data 232 and/or (e.g., sensed) operating parameters associated with vehicle 10, 100.

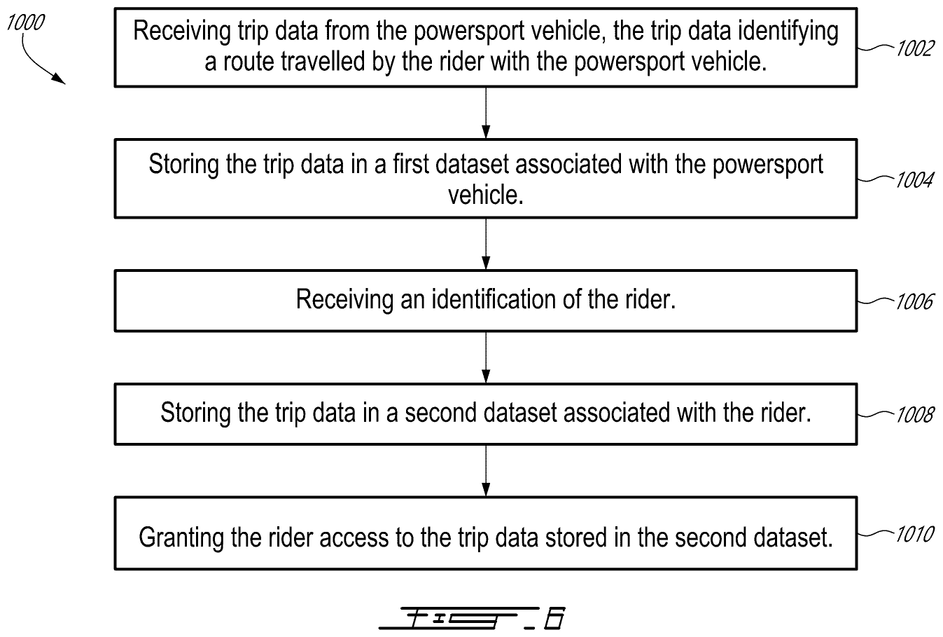

FIG. 6 is a flow diagram illustrating an exemplary method 1000 of communicating trip data 232 to the rider of a (e.g., powersport) vehicle such as watercraft 10 or snowmobile 100 as examples. Method 1000 may be performed using system 11 (shown in FIG. 5) described herein or using another system. Method 1000 may include other actions, elements of watercraft 10 or of snowmobile 100, and/or elements of system 11. In various embodiments, method 1000 may be performed at and by server 212 located remotely of vehicle 10, 100. Method 1000 may include:
receiving trip data 232 from vehicle 10, 100, trip data 232 identifying a route travelled by the rider with vehicle 10, 100 (block 1002);
storing trip data 232 in a first dataset (e.g., vehicle dataset 224) associated with vehicle 10, 100 (block 1004);
receiving an identification of the rider (e.g., rider ID 206) (block 1006);
storing trip data 232 in a second dataset (e.g., rider dataset 226) associated with the rider (block 1008); and
granting the rider access to trip data 232 stored in the second dataset (e.g., rider dataset 226) (block 1010).

Trip data 232 or part(s) thereof (e.g., some geographic coordinates 228) may be transmitted from vehicle 10, 100 to server 212 while vehicle 10, 100 is in transit (e.g., and substantially in real-time) along the route and when vehicle 10, 100 has suitable data connectivity with communication network 210. When vehicle 10, 100 is travelling through a region without suitable data connectivity with communication network 210 however, the trip data 232 may continue to be accumulated (i.e., collected in a buffer) by controller 90, 190 and stored onboard vehicle 10, 100. When data connectivity between vehicle 10, 100 and server 212 is restored, transmission of trip data 232 from vehicle 10, 100 to server 212 may be resumed. In various embodiments, transmission of trip data 232 from vehicle 10, 100 to server 212 may be substantially continuous or intermittent. In some embodiments, transmission of trip data 232 from vehicle 10, 100 to server 212 may be performed while vehicle 10, 100 is travelling the route or after the route has been completed.

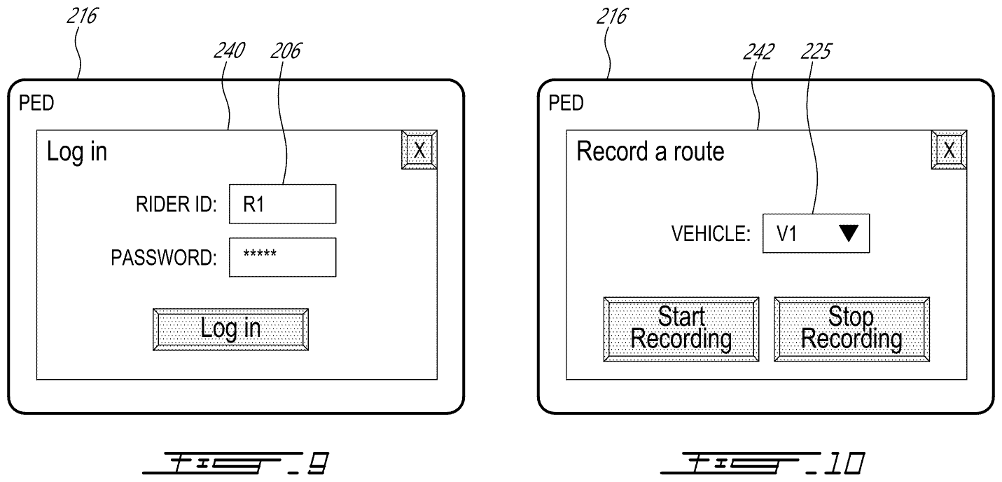

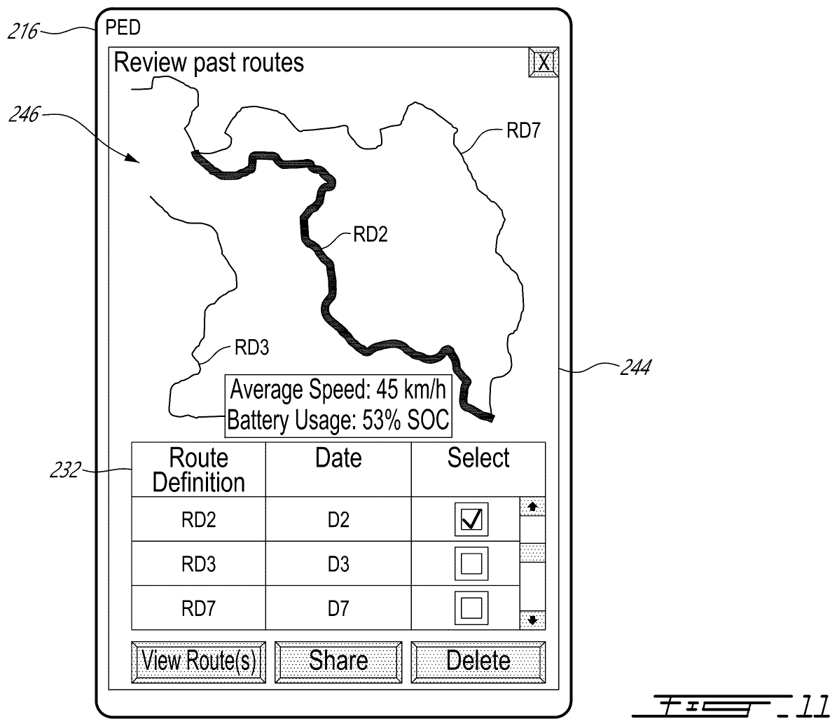

In order to populate rider dataset 226, server 212 may require the applicable rider ID 206 that is associated with a particular trip data 232. Rider ID 206 may be (e.g., wirelessly) transmitted from vehicle 10, 100 to server 212. As explained in relation to FIGS. 9 and 10 below, rider ID 206 may be (e.g., wirelessly) transmitted from PED 216 to server 212 or from PED 216 to vehicle 10, 100. When transmitted from vehicle 10, 100, rider ID 206 may be incorporated into trip data 232 or otherwise associated with trip data 232 when transmitted to server 212. In some embodiments, rider ID 206 may first be supplied to vehicle 10, 100 from PED 216 of the rider by way of data connectivity between PED 216 and vehicle 10, 100. Alternatively, rider ID 206 may correspond to an identification of key 200 used for activating vehicle 10, 100. Alternatively, rider ID 206 may be provided to vehicle 10, 100 manually via entry of an identification code and/or password in an instrument panel, or via the rider's PED 216 that is in communication with vehicle 10, 100.

Method 1000 may provide a ride tracking function that is relatively convenient for the rider whether the rider was an operator or a passenger of vehicle 10, 100 while travelling the route. For example, recording of trip data 232 including route definitions by server 212 into vehicle dataset 224 may be performed automatically without the rider's active initiation or involvement (i.e., without requiring any additional action from the rider). When rider ID 206 is provided to vehicle 10, 100 and automatically transmitted from vehicle 10, 100 to server 212, rider dataset 226 may be automatically populated with trip data 232 associated with the applicable rider ID 206. Alternatively, the association between rider ID 206 and vehicle 10, 100 may be previously provided to server 212 so that trip data 232 may automatically be assigned to the applicable rider ID 206. In these embodiments, the beginning and end of a route may be determined automatically by server 212 or by controller 90, 190 of vehicle 10, 100. For example, a route definition may be initiated upon vehicle 10, 100 being driven following a period of inactivity of a sufficient duration. Similarly, a route definition may be terminated when vehicle 10, 100 is stopped for a sufficient duration and/or is turned off for sufficient duration. Accordingly, ride tracking may be performed without requiring any additional action from the rider. The rider may then have access to the trip data 232 stored in rider dataset 226.

Rider ID 206 may be associated with a new route definition at the beginning of the new route, any time when the new route is being travelled, or after the new route has been completed. The association between rider ID 206 and the new trip data 232 may be made at vehicle 10, 100 and/or at server 212. For example, rider ID 206 may be transmitted to server 212 at the beginning of a new route and/or after a portion of the route has already been travelled. Rider ID 206 may be received at server 212 or at vehicle 10, 100 before any part of the route has been travelled, or after a portion of the route has already been travelled and before vehicle 10, 100 has completed travelling the route.

In some embodiments, when rider ID 206 is not known or provided at the beginning of a new route and part of the new route has already been travelled, a grace period may be provided to allow the rider to claim trip data 232 for the initial part of the route that has already been travelled. The grace period may provide flexibility to the rider as to when rider ID 206 needs to be provided (in case the rider forgets to provide rider ID 206) or otherwise associated with the new route. For example, at least part of trip data 232 may be received at server 212 from vehicle 10, 100 while vehicle 10, 100 is in transit along the route and before receiving rider ID 206 at server 212. In such situations, a time duration from when vehicle 10, 100 has begun travelling the route to when rider ID 206 is received is determined. When that time duration is determined to be within the prescribed grace period, the initial part of the route may be assigned to rider ID 206 and trip data 232 may be (e.g., copied from vehicle dataset 224 and) stored in rider dataset 226. In situations when the grace period is relied upon, trip data 232 stored in rider dataset 226 may also include the initial portion of the route travelled before rider ID 206 was provided. In various embodiments, the grace period may have a duration of 15 minutes, 30 minutes or 60 minutes for example. In some embodiments, the grace period may have a duration of hours or days. In some embodiments, the grace period may expire once a route has been completed.

Further aspects of method 1000 are described below in relation to the subsequent figures.

FIGS. 7 and 8 are schematic illustrations of exemplary contents of vehicle datasets 224A, 224B and rider datasets 226A, 226B. FIG. 7 illustrates a scenario where a plurality of riders R1, R2 may separately track their respective rides taken on a same vehicle 10, 100 (V1). First vehicle dataset 224A may be stored on server 212 and may contain utilization data collected from vehicle 10, 100 (V1) over a plurality of trips having trip identifications (referred hereinafter as “trip IDs”) T1-T5. The utilization data may include respective trip data 232 (e.g., route definitions RD1-RD5, battery SOCs SOC1-SOC5, vehicle speeds S1-S5) associated with routes travelled on dates D1-D5 by riders R1 and R2. First rider dataset 226A may be associated with first rider R1 and may contain the trip data 232 for trips T1-T3 that were travelled by first rider R1. Second rider dataset 226B may be associated with second rider R2 and may contain the trip data 232 for trips T4 and T5 that were travelled by second rider R2.

Rider datasets 226A, 226B may each include application personal data PD1-PD5 of the type explained above. In some embodiments, personal data PD1-PD5 may be omitted from first vehicle dataset 224A.

Rider datasets 226A and 226B may each contain a different subset of the utilization data stored in first vehicle dataset 224A. The utilization data stored in first vehicle dataset 224A may include one or more other data values such as additional data 238 associated with each trip ID T1-T5. Additional data 238 may be collected from vehicle 10, 100 mainly for engineering/maintenance purposes and may not be stored in rider datasets 226A, 226B.

In some embodiments, server 212 may initially receive the utilization data and store the utilization data in first vehicle dataset 224A associated with a specific vehicle ID 225. Using rider ID 206, server 212 may then copy the applicable trip data 232 to the respective rider dataset(s) 226A and 226B. Copying of the applicable trip data 232 is illustrated in FIG. 7 with arrows shown in broken lines. Alternatively, if rider ID 206 is known to server 212 when the utilization data is received, server 212 may write trip data 232 to both first vehicle dataset 224A and to the applicable rider dataset 226A, 226B substantially simultaneously. In various embodiments, one instance of trip data 232 may be stored in first vehicle dataset 224A for engineering/maintenance purposes and another instance of trip data 232 may be stored in the applicable rider dataset(s) 226A, 226B for ride tracking purposes. First rider R1 may be granted access to first rider dataset 226A, and second rider R2 may be granted access to second rider dataset 226B. First rider R1 may be denied access to first vehicle dataset 224A and to second rider dataset 226B. Second rider R2 may be denied access to first vehicle dataset 224A and to first rider dataset 226A. In some embodiments, rider datasets 226A, 226B may include in addition to route definitions, values that may be part of trip data 232 and shared with the rider such as battery consumption (SOC) or fuel consumption along the route, a travel distance for the route and vehicle speed (e.g., average, maximum) experienced during the route for example.

FIG. 8 illustrates another scenario where first rider R1 may track rides using multiple vehicles 10, 100 (e.g., V1 and V2). First vehicle dataset 224A may be stored on server 212 and may contain utilization data collected from vehicle 10, 100 (V1) associated with trip IDs T1-T5. The utilization data may include respective trip data 232 (e.g., route definitions RD1-RD5, battery SOCs SOC1-SOC5, vehicle speeds S1-S5) associated with routes travelled on dates D1-D5 by riders R1 and R2. Second vehicle dataset 224B may be stored on server 212 and may contain utilization data collected from vehicle 10, 100 (V2) associated with trip IDs T6-T10. The utilization data may include respective trip data 232 (e.g., route definitions RD6-RD10, battery SOCs SOC6-SOC10, vehicle speeds S6-S10) associated with routes travelled on dates D6-D10 by riders R1 and R3.

First rider dataset 226A may be associated with first rider R1 and may contain trip data 232 for trips T1-T3 from first vehicle dataset 224A and may also contain the trip data 232 for trips T7 and T8 from second vehicle dataset 224B. First rider dataset 226A may contain a first subset of the utilization data stored in first vehicle dataset 224A and a second subset of the utilization data stored in second vehicle dataset 224B. The utilization data stored in first vehicle dataset 224A and second vehicle dataset 224B may include one or more other data values such as additional data 238 associated with each trip ID T1-T10. Additional data 238 may be collected from vehicles 10, 100 (V1 and V2) mainly for engineering/maintenance purposes and may not be stored in first rider dataset 226A.

First rider R1 may be granted access to first rider dataset 226A so as to access the applicable trip data 232 travelled on both vehicles 10, 100 (V1 and V2). First rider R1 may be denied access to first vehicle dataset 224A and to second vehicle dataset 224B. Second rider dataset 226B for second rider R2 and a third rider dataset for third rider R3 may be constructed in the same manner using the utilization data sored in first vehicle dataset 224A and second vehicle dataset 224B.

FIG. 9 is an exemplary login window 242 for accessing a software application permitting a rider to manage trip information. The software application may be run on PED 216, which may be in (e.g., wireless) data communication with server 212 and/or with vehicle 10, 100. Login may be achieved by entering rider ID 206 and a valid password associated with rider ID 206, and depressing the “Log in” button. Logging in the software application may cause data communication to be established with server 212 and access being granted to the applicable rider dataset 226. In various embodiments, logging in the software application and/or performing another action within software application may constitute a request from the rider to server 212 to access trip data 232 that are stored in rider dataset 226. In embodiments where PED 216 is in data communication with vehicle 10, 100, rider ID 206 entered by the rider may be communicated to vehicle 10, 100 and rider ID 206 may in turn be communicated from vehicle 10, 100 to server 212.

FIG. 10 is an exemplary optional route recording window 242 of the software application permitting a rider to manually record trip information. In embodiments where rider ID 206 is not automatically provided to server 212, or in embodiments where the rider is permitted to manually control the recording of trip data 232 in rider dataset 226, route recording window 242 may be used by the rider for this purpose. Route recording window 242 may be used to enter vehicle ID 225 and also cause a route definition to be initiated by depressing the “Start Recording” button. The route definition may be terminated by depressing the “Stop Recording” button. In this manner, the rider may dictate the beginning and end of a route definition using route recording window 242.

FIG. 11 is an exemplary route reviewing window 244 of the software application permitting a rider to retroactively review and share trip information. Route reviewing window 244 may be provided on PED 216. In some embodiments, route reviewing window 244 may permit the rider to access trip data 232 including route definitions that are stored in rider dataset 226. In some embodiments, route reviewing window 244 may permit the user to select one or more route definitions RD2, RD3, RD7 for viewing (e.g., and highlighting) in map region 246 of route reviewing window 244. In some embodiments, route reviewing window 244 may permit the rider to delete selected ones or all route definitions that are stored in rider dataset 226. For example, route reviewing window 244 may permit the rider to clear their riding history. In some embodiments, route reviewing window 244 may permit the rider to share route definitions with friends via one or more electronic communication means or social media platforms.

Route reviewing window 244 may also permit the rider to access one or more other elements of trip data 232. For example, FIG. 11 shows an average speed of vehicle 10, 100 along the selected route definition, and also a battery usage to complete the selected route definition.

In some embodiments, a rider may be permitted to modify one or more route definitions using route reviewing window 244. For example, a rider may desire to split one trip into multiple trips, or combine two or more trips into one trip.

Aspects of the present disclosure may be embodied as systems, devices, methods and/or computer program products for communicating trip information to a rider of vehicle 10, 100. For example, aspects of the present disclosure may take the form of a computer program product embodied in one or more non-transitory computer readable medium(ia) (e.g., memory 220) having computer readable program code (e.g., instructions 222) embodied thereon. The program code may be readable and executable by one or more computers (e.g., server(s) 212), processor(s) or logic circuit(s) to perform method 1000.

As can be seen therefore, the examples described above and illustrated are intended to be exemplary only. The scope is indicated by the appended claims.

What is claimed is:

1. A method of communicating trip data to a rider of a powersport vehicle, the method comprising:
at a server located remotely of the powersport vehicle:
receiving the trip data from the powersport vehicle, the trip data identifying a route travelled by the rider with the powersport vehicle;
storing the trip data in a first dataset associated with the powersport vehicle;
receiving an identification of the rider;
storing the trip data in a second dataset associated with the rider; and
granting the rider access to the trip data stored in the second dataset.

2. The method as defined in claim 1, wherein receiving the trip data from the powersport vehicle includes receiving geographic coordinates from the powersport vehicle while the powersport vehicle is in transit.

3. The method as defined in claim 1, wherein receiving the trip data from the powersport vehicle includes receiving a travelling speed from the powersport vehicle while the powersport vehicle is in transit.

4. The method as defined in claim 1, wherein:
the powersport vehicle includes an electric powertrain; and
receiving the trip data from the powersport vehicle includes receiving a battery state-of-charge from the powersport vehicle while the powersport vehicle is in transit.

5. The method as defined in claim 1, wherein storing the trip data in the second dataset is performed in response to receiving the identification of the rider.

6. The method as defined in claim 1, comprising:
receiving additional data from the powersport vehicle, the additional data pertaining to the powersport vehicle and being different from the trip data; and
storing the additional data in the first dataset.

7. The method as defined in claim 6, wherein storing the trip data in the second dataset includes copying the trip data from the first dataset to the second dataset.

8. The method as defined in claim 7, comprising omitting the additional data from the second dataset.

9. The method as defined in claim 1, wherein part of the route is travelled by the rider with the powersport vehicle before receiving the identification of the rider at the server or at the powersport vehicle.

10. The method as defined in claim 9, comprising:
determining a time duration from when the powersport vehicle has begun travelling the route to when the identification of the rider is received at the server or at the powersport vehicle; and
determining that the time duration is within a prescribed grace period before storing the trip data in the second dataset,
wherein the trip data stored in the second dataset includes the part of the trip data received before receiving the identification of the rider at the server or at the powersport vehicle.

11. The method as defined in claim 1, wherein the identification of the rider is received at the server or at the powersport vehicle before the powersport vehicle has completed travelling the route.

12. The method as defined in claim 1, comprising denying the rider access to the first dataset.

13. The method as defined in claim 1, wherein:
the rider is a first rider;
the route is a first route;
the trip data is first trip data;
the method includes:
receiving second trip data from the powersport vehicle, the second trip data defining a second route travelled by a second rider using the powersport vehicle;
storing the second trip data on the server in the first dataset associated with the powersport vehicle;
receiving an identification of the second rider; and
storing the second trip data in a third dataset associated with the second rider.

14. The method as defined in claim 1, wherein:
the powersport vehicle is a first powersport vehicle;
the route is a first route;
the trip data is first trip data;
the method includes:
receiving second trip data from a second powersport vehicle, the second trip data defining a second route travelled by the rider using the second powersport vehicle;
storing the second trip data in a third dataset associated with the second powersport vehicle; and
storing the second trip data in the second dataset associated with the rider.

15. The method as defined in claim 14, comprising granting the rider access to the second trip data stored in the second dataset.

16. The method as defined in claim 1, wherein the first dataset includes data values that are not in the second dataset.

17. The method as defined in claim 1, wherein granting the rider access to the trip data stored in the second dataset includes transmitting the trip data to a device associated with the rider.

18. The method as defined in claim 1, comprising:
receiving personal data associated with the rider while travelling the route; and
storing the personal data with the trip data in the second dataset associated with the rider.

19. The method as defined in claim 18, wherein the personal data is omitted from the first dataset.

20. A system for communicating trip data to a rider of a powersport vehicle, the system comprising:
a server in wireless data communication with the powersport vehicle, the server including:
a receiver operable to receive the trip data from the powersport vehicle and to receive an identification of the rider, the trip data defining a route travelled by the rider with the powersport vehicle;
memory operable to store the trip data in a first dataset associated with the powersport vehicle and to store the trip data in a second dataset associated with the rider; and
a processor operable to grant the rider access to the trip data stored in the second dataset.
